(19) United States
(12) Patent Application Publication
(10) Pub. No.: US 2008/0205358 A1
(43) Pub. Date: Aug. 28, 2008

(54) Usage of network load information for rate adaptation purposes

(75) Inventor: Jari Jokela, Ylojarvi (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: NOKIA CORPORATION

(21) Appl. No.: 11/710,235

(22) Filed: Feb. 23, 2007

(51) Int. Cl. H04Q 7/24

(52) U.S. Cl. 370/338

(57) ABSTRACT

The present invention provides a method and apparatus that features obtaining in a terminal, node, point or device information containing one or more indications about a network load of a wireless short-range communication network; and adjusting rate adaptation logic in the terminal, node, point or device based on the network load information. The information may be obtained in a network control message, including one or more beacon and probe response frames having information about at least one of a load, an average access delay, available admission capacity, access delay, or some combination thereof, of the wireless short-range communication network. The wireless short-range communication network may take the form of a wireless local area network (WLAN), wireless fidelity network (Wi-Fi), an ultra wideband network (UWB) or other suitable network using beacon-based communications protocols either now known or later developed in the future.

### BACKGROUND OF THE INVENTION

1. Field of Invention

The present invention relates to the field of wireless short-range communication.

More particularly, the present invention provides enhanced means for a short-range communication device for performing optimal rate adaptation for communicating in a wireless short-range communication network based on information obtained from the wireless short-range communication network.

2. Description of Related Art

Modern society has quickly adopted, and become reliant upon, handheld devices for wireless communication. For example, cellular telephones continue to proliferate in the global marketplace due to technological improvements in both the quality of the communication and the functionality of the devices. These wireless communication devices have become commonplace for both personal and business use, allowing users to transmit and receive voice, text and graphical data from a multitude of geographic locations. The communication networks utilized by these devices span different frequencies and cover different transmission distances, each having strengths desirable for various applications.

Cellular networks facilitate wireless communication over large geographic areas. These network technologies have commonly been divided by generations, starting in the late 1970s to early 1980s with first generation (1G) analog cellular telephones that provided baseline voice communication, to modern digital cellular telephones. GSM is an example of a widely employed 2G digital cellular network communicating in the 900 MHZ/1.8 GHZ bands in Europe and at 850 MHz and 1.9 GHZ in the United States. This network provides voice communication and also supports the transmission of textual data via the Short Messaging Service (SMS). SMS allows a WCD to transmit and receive text messages of up to 160 characters, while providing data transfer to packet networks, ISDN and POTS users at 9.6 Kbps. The Multimedia Messaging Service (MMS), an enhanced messaging system allowing for the transmission of sound, graphics and video files in addition to simple text, has also become available in certain devices. Soon emerging technologies such as Digital Video Broadcasting for Handheld Devices (DVB-H) will make streaming digital video, and other similar content, available via direct transmission to a WCD. While long-range communication networks like GSM are a well-accepted means for transmitting and receiving data, due to cost, traffic and legislative concerns, these networks may not be appropriate for all data applications.

Short-range wireless networks provide communication solutions that avoid some of the problems seen in large cellular networks. Bluetooth® is an example of a short-range wireless technology quickly gaining acceptance in the marketplace. A user does not actively instigate a Bluetooth® network. Instead, a plurality of devices within operating range of each other may automatically form a network group called a “piconet”. Any device may promote itself to the master of the piconet, allowing it to control data exchanges with up to seven “active” slaves and 255 “parked” slaves. Active slaves exchange data based on the clock timing of the master. Parked slaves monitor a beacon signal in order to stay synchronized with the master. These devices continually switch between various active communication and power saving modes in order to transmit data to other piconet members. In addition to Bluetooth® other popular short-range wireless networks include WLAN (of which “Wi-Fi” local access points communicating in accordance with various IEEE 802.11x standards, is an example), Wireless USB (WUSB), Ultra Wideband (UWB), ZigBee (802.15.4, 802.15.4a), and UHF RFID. All of these wireless mediums have features and advantages that make them appropriate for various applications.

In recent years, wireless LAN technology has become very popular because of its advantage in price and bandwidth. Nowadays, wireless LAN is mainly used for Internet access, but real-time application like Voice over IP (VoIP) and video on demand (Vod) are identified as the future applications for wireless LAN. To support such new applications, IEEE 802.11e was standardized to define a new 802.11 medium access control (MAC) layer protocol. The IEEE 802.11e MAC is a standard to support Quality of Service (QoS), and 802.11e Hybrid Coordination Function (HCF) can support QoS in 802.11 networks. The HCF provides both a contention-based channel access, called enhanced distributed channel access (EDCA), and a controlled channel access, referred to as HCF controlled channel access (HCCA).

In current WLAN systems, rate adaptation algorithms are not standardized. Typical implementations perform rate adaptation based on acknowledge (ACK) information and/or link quality information. The problem with ACK based schemes is that it is difficult to distinguish whether the lack of ACK is due to poor link condition (which maybe due to external interference or too low transmission power to name a couple of non-limiting examples) or due to collision. If the lack of ACK is due to poor link, then the rate adaptation algorithm should decide to go to a more robust rate (if possible). Alternatively, if the lack of ACK is due to collision, it does not make sense to go to the more robust rate as it most likely will just increase the collision probability.

The terminal can use a link statistic to determine whether the lack of ACK is likely due to poor link or collision. However, in order to get the link statistic the terminal may need to successfully exchange frames with the AP or wait frames transmitted by the AP to get link estimate. The first option is not very doable as exchanging frames for just link adaptation purposes is likely introducing too big overhead. The second option would in some cases mean that the terminal may need to wait pretty long time until it receives frame from the AP. This happens especially if the terminal is near cell edge.

Moreover, there exists no known solutions to solve this rate adaptation problem in the art. The known related techniques include the following:

US 2006/0215561 discloses a cross-layer rate adaptation mechanism for a wireless local area network (WLAN) that can obtain the channel state by calculating the Eb/N0 ratio of an ACK frame transmitted from the receiver side. The mechanism determines the transmission rate of the next frame by referring to a predefined reduced mode table. When receiving an ACK frame fails, the mechanism can automatically lower the transmitting rate of the next transmission. Therefore, the method can reduce the damage to the system when ACK frame failure happens.

EP 142 48 02 discloses a data transmission rate adaptation in a wireless communication system that includes at least one transceiver configurable for communication over a wireless communication channel, the transceiver having a transmitter and a receiver, a method for controlling a data transmission rate of the at least one transceiver includes the steps of: (i) determining a signal quality characteristic corresponding to a signal received at the receiver by measuring a difference between one or more reference constellation points and one or more received constellation points, the signal quality characteristic representing an estimation of signal degradation; and (ii) modifying a data transmission rate of the transmitter based, at least in part, on the signal quality characteristic.

In addition, the reader is also referred to IEEE 802.11e and 802.11k specifications, including the most recent revisions thereto, which are also hereby incorporated in their entirety by reference.

In view of this, there is a need in the industry to solve the aforementioned rate adaptation problem in the art.

### SUMMARY OF THE INVENTION

The present invention provides a method and apparatus that features obtaining in a terminal, node, point or device information containing one or more indications about a network load of a wireless short-range communication network; and adjusting rate adaptation logic in the terminal, node, point or device based on the network load information.

The information may be obtained in a network control message, including one or more beacon and probe response frames having information about at least one of a load, an average access delay, available admission capacity, access delay, or some combination thereof, of the wireless short-range communication network, such as, e.g., a basic service set (BSS).

The wireless short-range communication network may take the form of a wireless local area network (WLAN), wireless fidelity network (Wi-Fi), an ultra wideband network (UWB) or other suitable network using beacon-based communications protocols either now known or later developed in the future.

In some embodiments of the present invention, the terminal, node, point or device may take the form of a station (STA) in such a wireless local area network (WLAN), and/or the network load information may be obtained from an access point (AP) in such a wireless local area network (WLAN).

In some embodiments of the present invention, the rate adaptation logic may be adjusted based on the following condition: if a station count<a threshold_sc and a channel utilization<a threshold_cu, then the rate adaptation logic=link based, else the rate adaptation logic=collision based, where the threshold_sc and the threshold_cu are thresholds for the station count and the channel utilization.

Moreover, in some embodiments of the present invention, the rate adaptation logic may be adjusted based on the following condition: if a station count<a threshold_sc and a channel utilization<a threshold_cu and an average access delay[i]<a threshold_ad[i], then the rate adaptation logic=link based, else the rate adaptation logic=collision based, where the threshold_sc and the threshold_cu are thresholds for the station count and the channel utilization, and the threshold _ad[i] is the average access delay threshold for a given access category. In this case, either all access categories are monitored or just selected ones, including voice and video, or access delays of lower categories are monitored as the delays are first noticed there and can be used as an early indication of increased collision probability, or some combination thereof.

Moreover still, in some embodiments of the present invention, the rate adaptation logic may be adjusted based on the following condition: if an access point (AP) average access delay<a threshold_ad, then the rate adaptation logic=link based, else the rate adaptation logic=collision based, where the threshold_ad is the average access delay threshold for a distributed coordination function (DCF).

In some embodiments of the present invention, the thresholds can be set differently depending on what type of traffic the terminal, node, point or device is sending, including if the terminal, node, point or device is sending voice traffic (which is having highest priority in the radio level), then the thresholds could be different than when best effort data is transmitted. The thresholds may also be different depending on the network type, i.e. in 802.11b networks the thresholds may be different than in 802.11a networks. In operation, the rate adaptation logic=link based means that the lack of acknowledgement (Ack) is most likely due to a poor link and the terminal, node, point or device should use a more robust rate (if possible), or the rate adaptation logic=collision based means that the lack of acknowledgement (Ack) is most likely due to collisions and the terminal, node, point or device should use the same rate.

In some embodiments of the present invention, the terminal, node, point or device may also use other information, such as received signal strength indication (RSSI) information, to select the correct rate and procedures to tune the rate selection in case of transmission failure.

The present invention may take the form of a system featuring a wireless short-range communication network having a terminal, node, point or device with one or more modules configured to obtain information containing one or more indications about a network load of the wireless short-range communication network, and with one or more modules configured to adjust rate adaptation logic based on the network load information.

The present invention may take the form of such a terminal, node, point or device featuring one or more modules configured to obtain information containing one or more indications about a network load of a wireless short-range communication network, and one or more modules configured to adjust rate adaptation logic based on the network load information.

The scope of the invention may also include a WLAN chipset for such a node, point, terminal or device in such a wireless local area network (WLAN) or other suitable network, as well as implementing the same in a computer program product with a program code, which program code is stored on a machine readable carrier, for carrying out the steps of the method according to the present invention. The method may also feature implementing the step of the method via a computer program running in a processor, controller or other suitable module in such a terminal, node, point or device, including a station (STA).

The scope of the invention may also include implementing the same in such a wireless network that may be interworking with a global system for mobile communications (GSM) service, a general packet radio service (GPRS), Universal Mobile Telecommunications System (UMTS) packet network architecture, or other suitable mobile services.

The present invention may take the form of a method featuring steps of transmitting a message to a wireless short-range communications network; detecting that no response to the message has been received; obtaining information indicative of characteristics of the wireless short-range communication network from a network control message, wherein the information includes one or more indications relating to network load of the network; and determining a rate adaptation logic based on the obtained information.

In effect, the whole thrust of the present invention is to use information obtained from beacon and probe response frames to fine tune the rate adaptation logic. More specifically, the idea of the present invention is to use information contained in new fields recently added to IEEE 802.11e and 802.11k Specifications to help in deciding optimal rate adaptation logic.

Then, when considering the actual rate adaptation logic, it is something that is up to the current implementation, but conventionally there has been no means for determining that the problems with receiving packet responses are based on collisions, instead of bad link quality. So, conventionally whenever rate adaptation has been performed the direction has been to make changes to more robust data rates, which increases the coverage, but in situations where the problem has occurred due to collisions, the actions directed to remedy the problem makes the situation even worse as with more robust data rate the actual time needed for transmitting a packet is longer, which increases the collision probability. So, if the rate adaptation is selected to be collision based according to the mechanisms presented in the present invention, the rate adaptation should not lead to selection of more robust data rates, which is the typical approach if the rate adaptation is selected to be link based.

The technique according to the present invention enables usage of ‘free’ information for the rate adaptation algorithm, and can be used to fine tune the rate adaptation logic.

### BRIEF DESCRIPTION OF THE DRAWING

The drawing includes the following Figures, which are not necessarily drawn to scale:

FIG. 1 shows typical parts of an IEEE 802.11 WLAN system according to some embodiments of the present invention.

FIGS. 2a and 2b show flow charts of the basic steps of some embodiments of the present invention.

FIG. 3 shows a WLAN enabled device in the form of a station (STA) according to some embodiments of the present invention.

FIG. 4 shows an exemplary WLAN chipset that may form part of the WILAN enabled device shown in FIG. 3 according to some embodiments of the present invention.

FIGS. 5a and 5b show diagrams of the Universal Mobile Telecommunications System (UMTS) packet network architecture according to some embodiments of the present invention.

### BEST MODE OF THE INVENTION

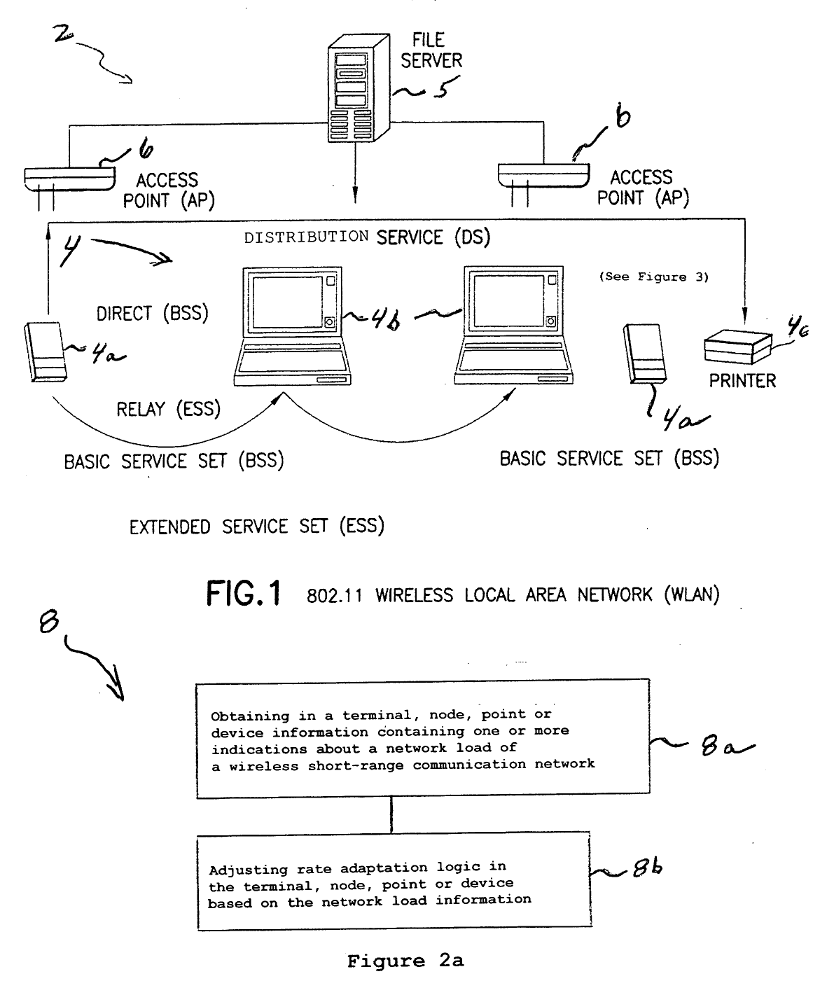

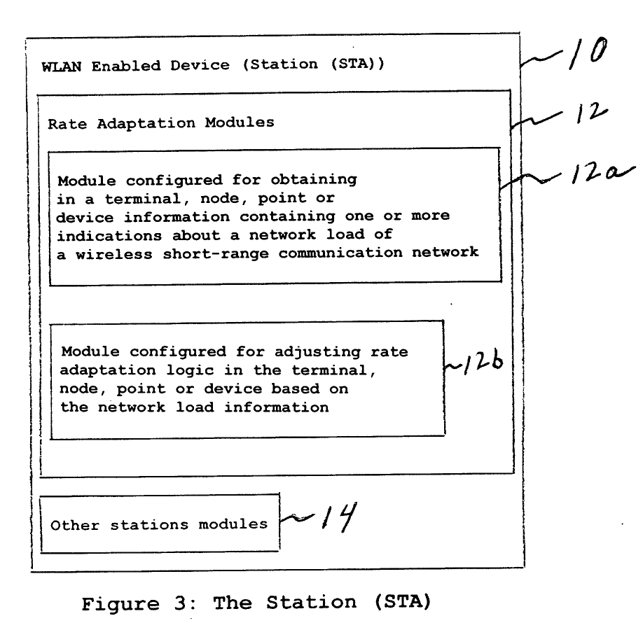

FIG. 1 shows, by way of example, a wireless network according to the present invention in the form of an IEEE 802.11 WLAN system, generally indicated as 2, which provides for communications between communications equipment such as mobile and secondary devices generally indicated as 4, including, by way of example, personal digital assistants 4a (PDAs), laptops 4b and printers 4c, etc. The WLAN system 2 may be connected to a wired LAN system that allows wireless devices to access information and files on a file server or other suitable device 5 or connecting to the Internet. The devices can communicate directly with each other in the absence of a base station in a so-called “ad-hoc” network, or they can communicate through a base station, called an access point (AP) in IEEE 802.11 terminology, generally indicated as 6, with distributed services through the AP 6 using local distributed services (DS) or wide area extended services, as shown. In a WLAN system, end user access terminals, nodes, points or devices are also known as stations 4 (STAs), shown in further detail in FIG. 3, which are transceivers (transmitters/receivers) that convert radio signals into digital signals that can be routed to and from communications device and connect the communications equipment to access points (APs) that receive and distribute data packets to other devices and/or networks. The STAs 4 may also take various other forms in addition to that set forth above ranging from wireless network interface card (NIC) adapters coupled to devices to integrated radio modules that are part of the devices, as well as an external adapter (USB), a PCMCIA card or a USB Dongle (self contained), which are all known in the art. It is important to note that the scope of the invention is intended to include implementing the same in other types or kinds of wireless networks, including wireless short-range communication networks like Bluetooth® (BT), ultra wide band (UWB), wireless USB or other suitable wireless networks using beacon-based communications protocols either now known or later developed in the future.

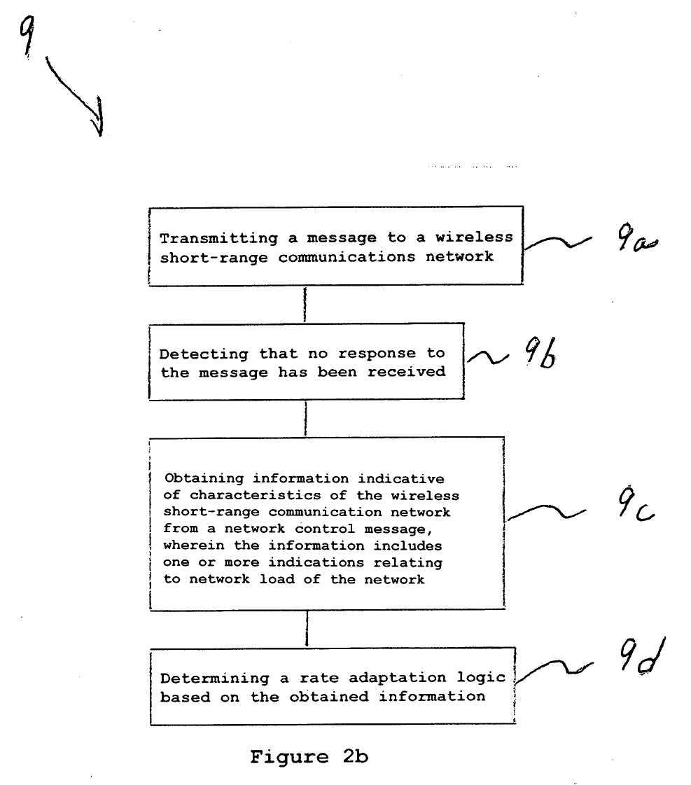

FIG. 2a show a flowchart generally indicated as 8 having the basic steps 8a and 8b for implementing the inventive method according to some embodiments of the present invention, including steps for obtaining in a terminal, node, point or device information containing one or more indications about a network load of a wireless short-range communication network (step 8a), and for adjusting rate adaptation logic in the terminal, node, point or device based on the network load information (step 8b). The scope of the invention is not intended to be limited to the order in which the steps in FIG. 2a are performed. These steps 8a, 8b may be implemented in one or more modules configured to do the same in such end user access terminals, nodes, points or devices like stations 4 (STAs).

In addition, FIG. 2b show a flowchart generally indicated as 9 having the basic steps 9a-9d for implementing the inventive method according to some embodiments of the present invention, including steps for transmitting a message to a wireless short-range communications network (step 9a), for detecting that no response to the message has been received (step 9b), for obtaining information indicative of characteristics of the wireless short-range communication network from a network control message, wherein the information includes one or more indications relating to network load of the network (step 9c); and determining a rate adaptation logic based on the obtained information (step 9d). The scope of the invention is not intended to be limited to the order in which the steps in FIG. 2b are performed. For example, in FIG. 2b the step 9c can be performed even before the step 9a, so when the terminal sends data and gets no response, such as, for example an ACK message back, it may use the information from previously received network control message, such as, for example a Beacon or Probe Response and not have to wait for the next Beacon or Probe Response to get the information. Similarly, these steps 9a-9d may be implemented in one or more modules configured to do the same in such end user access terminals, nodes, points or devices like stations 4 (STAs).

It is understood that the aforementioned methods may include other steps known in the art that do not form part of the underlying invention.

### The Basic Implementation

The present invention may be implemented, by way of example, as follows:

The whole thrust of the present invention is to use information obtained from a network control message, such as, for example transmitted beacon and probe response frames to help in deciding the rate adaptation logic according to embodiments of the present invention. Specifically, according to an embodiment of the present invention, the intention is to use new fields recently added by IEEE specification 802.11e (currently included in 802.11ma D9.0) and 802.11k (D7.0). These new fields include BSS Load, BSS Average Access Delay, BSS Available Admission Capacity and BSS AC Access Delay fields. It must be noticed that this information may be used as one input to the rate adaptation logic selection and the terminal may also use, e.g., link quality (RSSI/RCPI/SNR) information for rate adaptation logic selection as well.

In the following table it is shown what information these fields are including:

| Field | Parameters | Explanation |
|---|---|---|
| BSS Load (only QoS APs) | Station Count | Number of associated terminals |
| | Channel Utilization | Gives indication how busy the |
| | | medium is |
| | Available Admission | Overall available admission |
| | Capacity | capacity |
| BSS Average Access Delay | AP Average Access Delay | Gives average Distributed |
| | | Coordination Function (DCF) or |
| | | Enhanced Distributed Channel |
| | | Access (EDCA) access delay |
| BSS Available Admission | Available Admission | Available admission capacity per |
| Capacity (only QoS APs) | Capacity | User Priority (UP) |
| BSS AC Access Delay (only | AC Access Delay | Average access delay per Access |
| QoS APs) | | Category (AC). |

By using the information obtained from these fields, the terminal can adjust its rate adaptation logic as described in more detailed below in exemplary situations embodying the present invention. By using information in Beacons and Probe Responses, the STA can very quickly determine the best possible rate adaptation logic. In all cases it is assumed that the terminal may also use, e.g., RSSI information to select the correct rate and procedures described below can be used to fine tune the rate selection in case transmission failures occurs.

### EXAMPLE EMBODIMENT 1

### Only 802.11e is Supported (i.e., BSS Load is Available):

If Station Count<threshold_sc AND Channel Utilization<threshold_cu,

then the rate adaptation logic=link based,

else the rate adaptation logic=collision based,

where threshold_sc and threshold_cu are thresholds for station count and channel utilization.

The thresholds may be set differently depending on what type of traffic the terminal is sending. For example, if the terminal is sending voice traffic (which is having highest priority in the radio level) the thresholds could be different than when best effort data is transmitted. Thresholds may be different depending on the network type also, i.e. in 802.11b networks the thresholds may be different than in 802.11g or 802.11a networks.

### Example Scenario (Voice Terminal):

| 802.11a/g network | 802.11b network |
|---|---|
| threshold_sc = 10 | 5 |
| threshold_cu = 50% | 50% |

### Example Scenario (Data Terminal):

| 802.11a/g network | 802.11b network |
|---|---|
| threshold_sc = 15 | 8 |
| threshold_cu = 60% | 60% |

The rate adaptation logic=link based means that the lack of a response message, such as, e.g. an ACK message, is most likely due to a poor link condition and a terminal should use a more robust rate (if possible), while the rate adaptation logic=collision based means that the lack of response message, such as, e.g. the ACK message, is most likely due to collisions and the terminal should use the same rate.

### EXAMPLE EMBODIMENT 2

### Both 802.11e and 802.11k are Supported (i.e., All Four Fields are Available):

If the station count<the threshold_sc and the channel utilization<the threshold_cu and the average access delay[i]<threshold_ad[i],

then the rate adaptation logic=link based,

else the rate adaptation logic=collision based,

where the threshold_sc and the threshold_cu are thresholds for the station count and the channel utilization, and the threshold_ad[i] is average access delay threshold for given access category.

In this algorithm either all the access categories can be monitored, or just selected ones (e.g. Voice and Video) depending on the embodiment. On the other hand, it may be meaningful to monitor the access delays of lower priority access categories as the delays are first noticed there and that can be used as an early indication of increased collision probability.

The thresholds may be set differently depending on what type of traffic the terminal is sending. For example, if the terminal is sending voice traffic (which is having highest priority in the radio level) the thresholds could be different than in case of best effort data is transmitted. Terminal can also use e.g., Available Admission Capacity per user priority (UP) to determine suitable thresholds for given traffic situation.

### Example Scenario (Voice Terminal):

| 802.11a/g network | 802.11b network |
|---|---|
| threshold_sc = 10 | 5 |
| threshold_cu = 50% | 50% |
| threshold_ad[voice] = 2000 us | 12000 us |

### Example Scenario (Data Terminal):

| 802.11a/g network | 802.11b network |
|---|---|
| threshold_sc = 15 | 8 |
| threshold_cu = 60% | 60% |
| threshold_ad[BE] = 6000 us | 20000 us |

The rate adaptation logic=link based means that the lack of the response message, such as, e.g. the ACK message is most likely due to a poor link condition and the terminal should use a more robust rate, and the rate adaptation logic=collision based means that the lack of the response message, such as, e.g. the ACK message, is most likely due to collisions and the terminal should use the same rate.

### EXAMPLE EMBODIMENT 3

### Only 802.11k is Supported (i.e., Only BSS Average Access Delay is Available):

If the AP Average Access Delay<the threshold_ad,

then the rate adaptation logic=link based,

else the rate adaptation logic=collision based,

where the threshold _ad is the average access delay threshold for DCF. In this case the thresholds can be the same as in previous example:

| 802.11a/g network | 802.11b network |
|---|---|
| threshold_ad = 6000 us | 20000 us |

The rate adaptation logic=link based means that the lack of the response message, such as, e.g. the ACK message, is most likely due to a poor link and the terminal should use a more robust rate, and the rate adaptation logic=collision based means that the lack of the response message, such as, e.g. the ACK message, is most likely due to collisions and terminal should use the same rate.

### Device Implementation

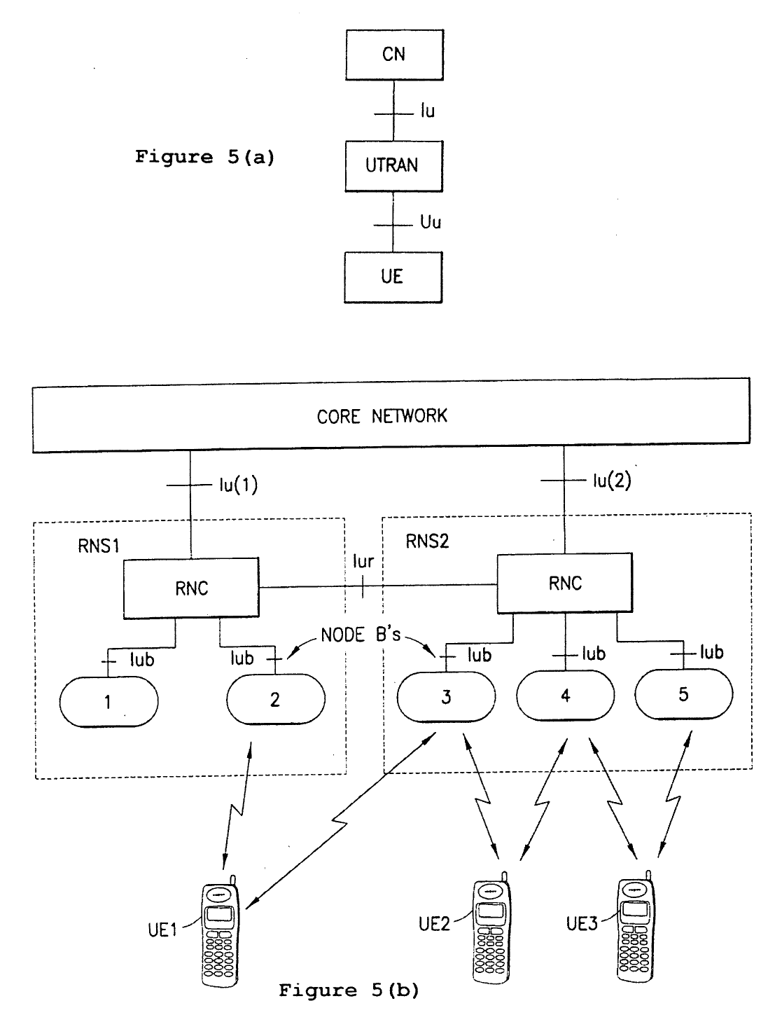

FIG. 3 shows, by way of example, one such terminal, node, point or device 4 (see FIG. 1) in the form of a WLAN enabled device generally indicated as 10 according to some embodiments of the present invention for the wireless local area network (WLAN) 2 or other suitable network such as that shown in FIGS. 1, 5a and 5b. The WLAN enabled device 10 has one or more rate adaptation logic modules 12, including a module 12a configured for obtaining in the terminal, node, point or device information containing one or more indications about a network load of a wireless short-range communication network, and a module 12b configured for adjusting rate adaptation logic in the terminal, node, point or device based on the network load information.

Consistent with that described above, the WLAN enabled device 10 is shown in the form of a station (STA) or other suitable node, point, terminal or device either now known or developed in the future for operating in such a wireless local area network (WLAN) or other suitable network such as that shown in FIGS. 1, 5a and 5b. The WLAN enabled device 10 may also have other device modules 14 that do not necessarily form part of the underlying invention and are not described in detail herein.

### Implementation of the Functionality of Modules 12a and 12b

By way of example, and consistent with that described herein, the functionality of the modules 12, 12a and/or 12b may be implemented using hardware, software, firmware, or a combination thereof, although the scope of the invention is not intended to be limited to any particular embodiment thereof. In a typical software implementation, the modules 12a and 12b would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the modules 12a and 12b being a stand alone module, as shown, or in the combination with other circuitry for implementing another module. Moreover, the real-time part may be implemented in hardware, while non real-time part may be done in software.

The other station modules 14 may also include other modules, circuits, devices that do not form part of the underlying invention per se. The functionality of the other modules, circuits, device that do not form part of the underlying invention are known in the art and are not described in detail herein.

### The WLAN Chipset

The present invention may also include one or more of the modules 12, 12a, 12b, 14 in FIG. 3 forming part of a chipset. For example, a WLAN chipset for such a node, point, terminal or device in such a wireless local area network (WLAN) or other suitable network may include a number of integrated circuits designed to perform one or more related functions. For example, one chipset may provide the basic functions of a modem while another provides the CPU functions for a computer. Newer chipsets generally include functions provided by two or more older chipsets. In some cases, older chipsets that required two or more physical chips can be replaced with a chipset on one chip. The term “chipset” is also intended to include the core functionality of a motherboard in such a node, point, terminal or device.

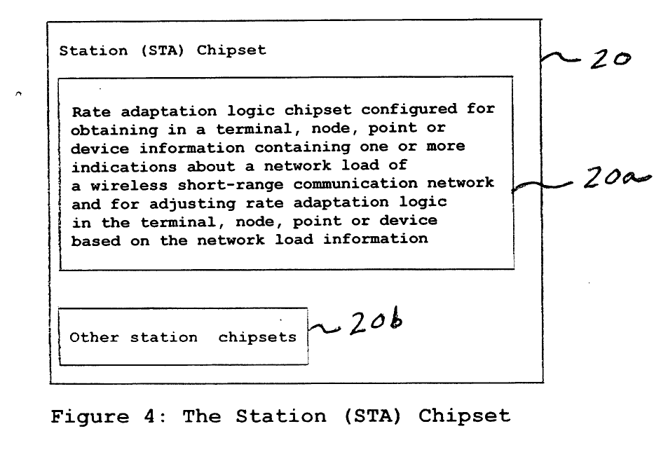

In particular, FIG. 4 shows an example of a station chipset 20 in further detail, that includes a rate adaptation chipset 20a configured for obtaining in the terminal, node, point or device information containing one or more indications about a network load of a wireless short-range communication network, and for adjusting rate adaptation logic in the terminal, node, point or device based on the network load information, according to some embodiments of the present invention. The station chipset 20 may also include other chipset modules 20b that do not necessarily form part of the underlying invention and are not described in detail herein. Although the present invention is described in the form of one or more stand alone modules for the purpose of describing the same, the scope of the invention is invention is intended to include the functionality of the rate adaptation logic chipset 20a being implemented in whole or in part by one or more of these other chipset modules 20b. In other words, the scope of the invention is not intended to be limited to where the functionality of the present invention is implemented in the chipset 20a alone.

### Universal Mobile Telecommunications System (UMTS) Packet Network Architecture

FIGS. 5a and 5b show diagrams of the Universal Mobile Telecommunications System (UMTS) packet network architecture. In FIG. 5a, the UMTS packet network architecture includes the major architectural elements of user equipment (UE), UMTS Terrestrial Radio Access Network (UTRAN), and core network (CN). The UE is interfaced to the UTRAN over a radio (Uu) interface, while the UTRAN interfaces to the core network (CN) over a (wired) Iu interface. FIG. 5b shows some further details of the architecture, particularly the UTRAN, which includes multiple Radio Network Subsystems (RNSs), each of which contains at least one Radio Network Controller (RNC). In operation, each RNC may be connected to multiple Node Bs which are the UMTS counterparts to GSM base stations. Each Node B may be in radio contact with multiple UEs via the radio interface (Uu) shown in FIG. 5a. A given UE may be in radio contact with multiple Node Bs even if one or more of the Node Bs are connected to different RNCs. For instance, a UE1 in FIG. 5b may be in radio contact with Node B2 of RNS1 and Node B3 of RNS2 where Node B2 and Node B3 are neighboring Node Bs. The RNCs of different RNSs may be connected by an Iur interface which allows mobile UEs to stay in contact with both RNCs while traversing from a cell belonging to a Node B of one RNC to a cell belonging to a Node B of another RNC. The convergence of the IEEE 802.11 WLAN system in FIG. 1 and the (UMTS) packet network architecture in FIGS. 5a and 5b has resulted in STAs taking the form of UEs, such as mobile phones or mobile terminals. The interworking of the WLAN (IEEE 802.11) shown in FIG. 1 with such other technologies (e.g. 3GPP, 3GPP2 or 802.16) such as that shown in FIGS. 5a and 5b is being defined at present in protocol specifications for 3GPP and 3GPP2. The scope of the invention is intended to include implementing the same in such a UMTS packet network architecture as shown in FIGS. 5a and 5b, or in a WLAN or other suitable network that uses beacon-based communication protocols in conjunction with the UMTS packet network architecture shown in FIGS. 5a and 5b.

### List of Abbreviations

The following is a list of abbreviations:

TABLE 1
List of abbreviations

| | |
|---|---|
| AP | Access Point |
| BER | Bit Error Rate |
| BSA | Basic Service Area |
| BSS | Basic Service Set |
| BT | Bluetooth ® |
| dBm | deciBels referred to 1 mW |
| DS | Distribution System |
| ESS | Extended Service Set |
| FIFO | First In First Out |
| GAN | Generalized Access Network |
| GPRS | General Packet Radio Service |
| GSM | Global System for Mobile communications |
| HO | HandOver |
| IEEE | Institute of Electrical and Electronics |
| | Engineers |
| MAC | Medium Access Control |
| MCU | Micro Controller Unit |
| PC | Personal Computer |
| PHY | Physical layer |
| PDA | Personal Digital Assistant |
| RCPI | Received Channel Power Indicator |
| RF | Radio Frequency |
| RSSI | Received Signal Strength Indicator |
| STA | Station |
| SW | Software |
| UMA | Unlicensed Medium Access |
| WLAN | Wireless Local Area Network |

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

1. A method comprising:
obtaining in a terminal, node, point or device information containing one or more indications about a network load of a wireless short-range communication network; and
adjusting rate adaptation logic in the terminal, node, point or device based on the network load information.

2. A method according to claim 1, wherein the information is obtained in a network control message, including one or more beacon and probe response frames including information about at least one of a load, an average access delay, available admission capacity, access delay, or some combination thereof, of the wireless short-range communication network.

3. A method according to claim 1, wherein the network load information is obtained from an access point in a wireless local area network.

4. A method according to claim 1, wherein the rate adaptation logic is adjusted based on the following condition:
if a station count<a threshold_sc and a channel utilization<a threshold_cu,
then the rate adaptation logic=link based,
else the rate adaptation logic=collision based,
where the threshold_sc and the threshold_cu are thresholds for the station count and the channel utilization.

5. A method according to claim 4, wherein the thresholds can be set differently depending on what type of traffic the terminal, node, point or device is sending.

6. A method according to claim 4, wherein the thresholds can be set differently depending on the network type.

7. A method according to claim 4, wherein
the rate adaptation logic=link based means that the lack of acknowledgement is most likely due to a poor link and the terminal, node, point or device should use a more robust rate (if possible), or
the rate adaptation logic=collision based means that the lack of acknowledgement is most likely due to collisions and the terminal, node, point or device should use the same rate.

8. A method according to claim 1, wherein the rate adaptation logic is adjusted based on the following condition:
if a station count<a threshold_sc and a channel utilization<a threshold_cu and an average access delay<a threshold_ad,
then the rate adaptation logic=link based,
else the rate adaptation logic=collision based,
where the threshold_sc and the threshold_cu are thresholds for the station count and the channel utilization, and the threshold_ad is the average access delay threshold for a given access category.

9. A method according to claim 8, wherein the thresholds can be set differently depending on what type of traffic the terminal is sending.

10. A method according to claim 8, wherein the terminal, node, point or device can also use available admission capacity per user priority to determine suitable thresholds for a given traffic situation.

11. A method according to claim 8, wherein
the rate adaptation logic=link based means that the lack of acknowledgement is most likely due to poor link and the terminal, node, point or device should use a more robust rate (if possible), or
the rate adaptation logic=collision based means that the lack of acknowledgement is most likely due to collisions and the terminal, node, point or device should use the same rate.

12. A method according to claim 1, wherein the rate adaptation logic is adjusted based on the following condition:
if an access point average access delay<a threshold_ad
then the rate adaptation logic=link based,
else the rate adaptation logic=collision based,
where the threshold_ad is the average access delay threshold for a distributed coordination function.

13. A method according to claim 12, wherein
the rate adaptation logic=link based means that the lack of acknowledgement is most likely due to poor link and the terminal, node, point or device should use a more robust rate (if possible), or
the rate adaptation logic=collision based means that the lack of acknowledgement is most likely due to collisions and the terminal, node, point or device should use the same rate.

14. A method according to claim 1, wherein the terminal, node, point or device includes received signal strength indication information in selecting a correct rate for subsequent communication.

15. A terminal, node, point or device comprising:
one or more modules configured to obtain information containing one or more indications about a network load of a wireless short-range communication network; and
one or more modules configured to adjust rate adaptation logic based on the network load information.

16. A terminal, node, point or device according to claim 15, wherein the information is obtained in a network control message, including one or more beacon and probe response frames including information about at least one of a load, an average access delay, available admission capacity, access delay, or some combination thereof, of the wireless short-range communication network.

17. A terminal, node, point or device according to claim 15, wherein the wireless short-range communication network is a wireless local area network, wireless fidelity network, an ultra wideband network or other suitable network using beacon-based communications protocols.

18. A terminal, node, point or device according to claim 15, wherein the terminal, node, point or device is a station in a wireless local area network.

19. A terminal, node, point or device according to claim 15, wherein the network load information is obtained from an access point in a wireless local area network.

20. A terminal, node, point or device according to claim 15, wherein the rate adaptation logic is adjusted based on the following condition:
if a station count<a threshold_sc and a channel utilization<a threshold_cu,
then the rate adaptation logic=link based,
else the rate adaptation logic=collision based,
where the threshold_sc and the threshold_cu are thresholds for the station count and the channel utilization.

21. A terminal, node, point or device according to claim 20, wherein the thresholds can be set differently depending on what type of traffic the terminal, node, point or device is sending.

22. A terminal, node, point or device according to claim 20, wherein the thresholds can be set differently depending on the network type.

23. A terminal, node, point or device according to claim 20, wherein
the rate adaptation logic=link based means that the lack of acknowledgement is most likely due to poor link and the terminal, node, point or device should use a more robust rate (if possible), or
the rate adaptation logic=collision based means that the lack of acknowledgement most likely due to collisions and the terminal, node, point or device should use the same rate.

24. A terminal, node, point or device according to claim 15, wherein the rate adaptation logic is adjusted based on the following condition:
if a station count<a threshold_sc and a channel utilization<a threshold_cu and an average access delay<a threshold_ad,
then the rate adaptation logic=link based,
else the rate adaptation logic=collision based,
where the threshold_sc and the threshold_cu are thresholds for the station count and the channel utilization, and the threshold_ad is the average access delay threshold for a given access category.

25. A terminal, node, point or device according to claim 24, wherein the thresholds can be set differently depending on what type of traffic the terminal is sending.

26. A terminal, node, point or device according to claim 24, wherein the terminal, node, point or device can also use available admission capacity per user priority to determine suitable thresholds for a given traffic situation.

27. A terminal, node, point or device according to claim 24, wherein
the rate adaptation logic=link based means that the lack of acknowledgement is most likely due to poor link and the terminal, node, point or device should use a more robust rate (if possible), or
the rate adaptation logic=collision based means that the lack of acknowledgement is most likely due to collisions and the terminal, node, point or device should use the same rate.

28. A terminal, node, point or device according to claim 15, wherein the rate adaptation logic is adjusted based on the following condition:
if an access point average access delay<a threshold_ad
then the rate adaptation logic=link based,
else the rate adaptation logic=collision based,
where the threshold_ad is the average access delay threshold for a distributed coordination function

29. A terminal, node, point or device according to claim 28, wherein
the rate adaptation logic=link based means that the lack of acknowledgement is most likely due to poor link and the terminal, node, point or device should use a more robust rate (if possible), or
the rate adaptation logic=collision based means that the lack of acknowledgement is most likely due to collisions and the terminal, node, point or device should use the same rate.

30. A terminal, node, point or device according to claim 15, wherein the terminal, node, point or device includes received signal strength indication information in selecting a correct rate for subsequent communication.

31. A computer program product with a program code, which program code is stored on a machine readable carrier, for carrying out the steps of a method comprising obtaining in a terminal, node, point or device information containing one or more indications about a network load of a wireless short-range communication network, and adjusting rate adaptation logic in the terminal, node, point or device based on the network load information, when the computer program is run in a module of the terminal, node, point or device, such as a station.

32. A method according to claim 1, wherein the method further comprises implementing the step of the method via a computer program running in a processor, controller or other suitable module in one or more terminals, nodes, points or devices in the wireless short-range communication network.

33. Apparatus comprising:
means for obtaining in a terminal, node, point or device information containing one or more indications about a network load of a wireless short-range communication network; and
means for adjusting rate adaptation logic in the terminal, node, point or device based on the network load information.

34. Apparatus according to claim 33, wherein the information is obtained in a network control message, including one or more beacon and probe response frames including information about at least one of a load, an average access delay, available admission capacity, access delay, or some combination thereof, of the wireless short-range communication network).

35. A method comprising:
transmitting a message to a wireless short-range communications network;
detecting that no response to the message has been received;
obtaining information indicative of characteristics of the wireless short-range communication network from a network control message, wherein the information includes one or more indications relating to network load of the network; and
determining a rate adaptation logic based on the obtained information.
